(19) United States
(12) Patent Application Publication
(10) Pub. No.: US 2007/0090773 A1
(43) Pub. Date: Apr. 26, 2007

(54) DISCHARGE LAMP LIGHTING CIRCUIT WITH AN OPEN PROTECTION CIRCUIT

(76) Inventors: Shin-Hong Chung, Shenzhen (CN); Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/309,133

(22) Filed: Jun. 27, 2006

(30) Foreign Application Priority Data
Oct. 20, 2005 (CN) 200510100543.1

(51) Int. Cl. H05B 41/36

(52) U.S. Cl. 315/291

(57) ABSTRACT

A discharge lamp lighting circuit includes a plurality of discharge lamps, a driving circuit, a control circuit, an open protection circuit, which are connected in series. The open protection circuit includes an open control circuit, a delay circuit, and a plurality of open detecting circuits connected in series. Each of the open detecting circuits is connected to a corresponding one of the discharge lamps. One terminal of the open control circuit is connected to the control circuit, and the other terminal of the open control circuit is connected to one terminal of the delay circuit and a predetermined one of the open detecting circuits. The other terminal of the delay circuit is connected to another predetermined one of the open detecting circuits and ground.

### FIELD OF THE INVENTION

The present invention relates to a discharge lamp lighting circuit, and more particularly to a discharge lamp lighting circuit with an open protection circuit.

### DESCRIPTION OF RELATED ART

A discharge lamp, especially a rare gas discharge lamp, is used in lighting devices, various scanners, and Liquid Crystal Displays (LCDs). A discharge lamp has a rare gas such as xenon filled in a glass tube. The glass tube is coated with a fluorescent material on an inner wall of the glass tube, and the rare gas functions as a discharge gas. The discharge lamp is often lighted up by applying a high voltage thereto. The high voltage is obtained by switching a direct current (DC) power source. A primary voltage induced in a transformer is oscillated by a resonant circuit composed of an inductance of the transformer and a stray capacitance at a same time of switching. The primary voltage is applied to the semiconductor for driving and a secondary voltage of the transformer rise.

When a rare gas discharge lamp is not connected or is unlit, the primary voltage of the transformer rises further thereby possibly destroying the semiconductor for driving. At the same time, the secondary voltage of the transformer also rises further generating a high voltage equivalent to a starting voltage continuously; this may result in a dielectric breakdown of the transformer.

In order to solve the above problems, a discharge lamp lighting circuit with an open protection circuit has been devised. Referring to FIG. 3, an exemplary of such discharge lamp lighting circuit includes: a driving means to send a signal to fire a discharge lamp; a control means to control the driving means; a short protection means to protect the driving means by sending a signal to the control means when the discharge lamp is shorted; and an open protection means to protect the driving means by sending a signal to the control means when the discharge lamp is not connected or is unlit.

The open protection means is adapted to send a signal to the control means for limiting a current flowing through the driving means to be at or below a predetermined value when the current is equal to or lower than a predetermined first value, and a signal for sequentially increasing a current flowing through the driving means up to a predetermined current when the current is higher than the predetermined first value and also is equal to or lower than a predetermined second value. The open protection means is also used to stop a driving signal sent from the control means when a current flowing through the discharge lamp has a value equal to or lower than the first value after a predetermined time. Therefore, the discharge lamp lighting circuit can be protected when the discharge lamp is in an open state. However, the invention only discloses a technique involving a discharge lamp lighting circuit with one discharge lamp.

Therefore, a heretofore unaddressed need exists in the industry to overcome the aforementioned deficiencies and inadequacies.

### SUMMARY OF INVENTION

A discharge lamp lighting circuit with an open protection circuit is provided for detecting a current of a plurality of discharge lamps, and for stopping a current flowing to a buck converter when any of the discharge lamps is not connected or is unlit.

In one preferred embodiment, the discharge lamp lighting circuit includes a plurality of discharge lamps, a driving circuit, a control circuit, an open protection circuit, which are connected in series. The control circuit controls the driving circuit to power the discharge lamps. The open protection circuit includes an open detecting unit, an open control circuit, and a delay circuit. The open detecting unit includes a plurality of open detecting circuits connected in series. Each open detecting circuit is connected to a corresponding one of the discharge lamps. A first predetermined one of the open detecting circuits is connected to the open control circuit. A second predetermined one of the open detecting circuits is connected to one terminal of the delay circuit and ground. One terminal of the open control circuit is connected to the control circuit, and the other terminal of the open control circuit is connected to the other terminal of the delay circuit and the first predetermined one of the open detecting circuits. Each of the open detecting circuits detects whether the corresponding discharge lamp is unlit. If the corresponding discharge lamp is not lit, the open control circuit sends a voltage control signal to the control circuit, which in turn ceases operating.

An open protection circuit is connected in series between a plurality of power consumers and a control circuit. The control circuit is configured for controlling a driving circuit to powering the power consumers. The open protection circuit includes an open detecting unit, an open control circuit, and a delay circuit. The open detecting unit includes a plurality of open detecting circuits connected in series. Each open detecting circuit is connected to a corresponding one of the discharge lamps. A first predetermined one of the open detecting circuits is connected to the open control circuit. A second predetermined one of the open detecting circuits is connected to one terminal of the delay circuit and ground. One terminal of the open control circuit is connected to the control circuit, and the other terminal of the open control circuit is connected to the other terminal of the delay circuit and the first predetermined one of the open detecting circuits. Each of the open detecting circuits detects whether the corresponding discharge lamp is unlit. If the corresponding discharge lamp is not lit, the open control circuit sends a voltage control signal to the control circuit, which in turn ceases operating.

Other systems, methods, features, and advantages will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF DRAWINGS

FIG. 1 is a block diagram of a discharge lamp lighting circuit with an open protection circuit according to a preferred embodiment of the present invention;

FIG. 2 is a block diagram showing circuitry of a discharge lamp lighting circuit with an open protection circuit according to a preferred embodiment of the present invention; and

FIG. 3 is a diagram of a conventional discharge lamp lighting circuit with an open protection circuit.

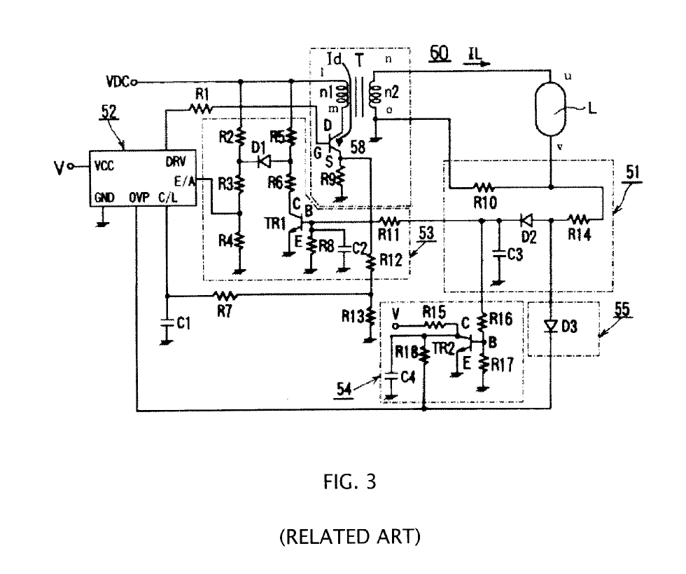

### DETAILED DESCRIPTION

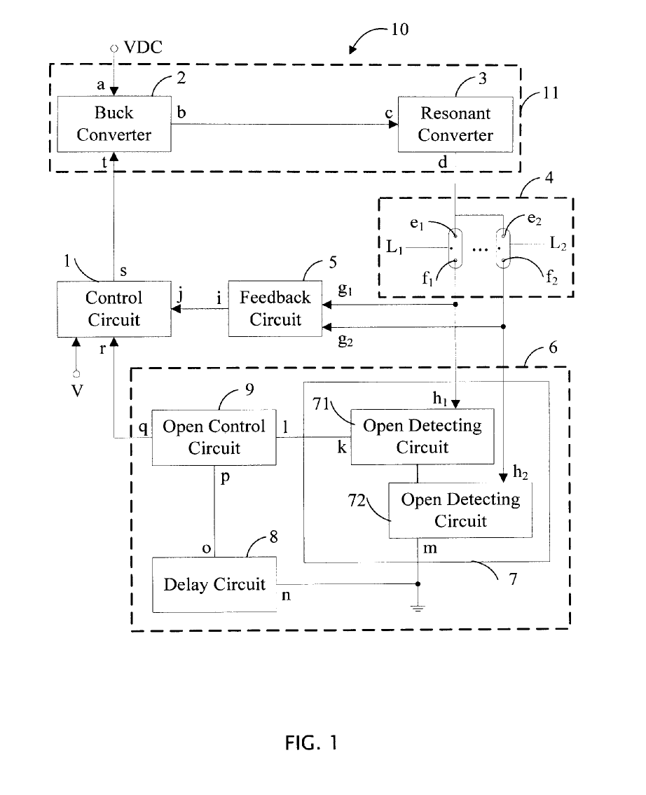

FIG. 1 is a block diagram of a discharge lamp lighting circuit 10 with an open protection circuit in accordance with a preferred embodiment of the present invention. In this embodiment, the discharge lamp lighting circuit 10 includes a control circuit 1, a driving circuit 11, a plurality of discharge lamps 4, a feedback circuit 5, and an open protection circuit 6. The driving circuit 11 includes a buck converter 2 and a resonant converter 3. The open protection circuit 6 includes an open detecting unit 7, a delay circuit 8, and an open control circuit 9. In the illustrated embodiment, for simplicity, two discharge lamps L₁ and L₂ are depicted; the open detecting unit 7 includes two open detecting circuits 71 and 72 each corresponds to a respective one of the discharge lamps L₁ and L₂. The discharge lamps 4 may be a kind of rare gas discharge lamps, such as fluorescent lamps, xenon lamps, and/or Cold Cathode Fluorescent Lamps (CCFLs).

A terminal ‘s’ of the control circuit 1 is connected to a terminal ‘t’ of the buck converter 2. A terminal ‘a’ of the buck converter 2 is connected to a direct current (DC) power supply (not shown) of a voltage VDC. A terminal ‘b’ of the buck converter 2 is connected to a terminal ‘c’ of the resonant converter 3.

A terminal ‘d’ of the resonant converter 3 is connected to terminals (symbolically depicted as e₁ and e₂) of each discharge lamp 4. Terminals (symbolically depicted as f₁ and f₂) of each discharge lamp 4 are connected to terminals (symbolically depicted as g₁ and g₂) of the feedback circuit 5 and to terminals (symbolically depicted as h₁ and h₂) of the open detecting circuits 71 and 72 correspondingly.

A terminal ‘i’ of the feedback circuit 5 is connected to a terminal ‘j’ of the control circuit 1. A terminal ‘k’ of the open detecting unit 7 is connected to a terminal ‘l’ of the open control circuit 9. A terminal ‘m’ of the open detecting unit 7 is connected to a terminal ‘n’ of the delay circuit 8. A terminal ‘o’ of the delay circuit 8 is connected to a terminal ‘p’ of the open control circuit 9. A terminal ‘q’ of the open control circuit 9 is connected to a terminal ‘r’ of the control circuit 1.

When power (not shown) is supplied to the control circuit 1, the control circuit 1 generates a normal pulse signal with a default duty cycle, and sends the normal pulse signal to the buck converter 2. The buck converter 2 receives a DC voltage from the DC power supply (not shown) of the voltage VDC, and converts the DC voltage into a lower DC voltage according to the normal pulse signal from the control circuit 1.

The resonant converter 3 converts the lower DC voltage from the buck converter 2 into a higher alternating current (AC) voltage so as to light the discharge lamps 4. Driven by the higher AC voltage, each of the discharge lamps 4 is normally lit, and each discharge lamp 4 correspondingly outputs an AC signal to the feedback circuit 5 and the open protection circuit 6.

Upon receiving the AC signal from the discharge lamps 4, the feedback circuit 5 feedbacks a first voltage control signal to the control circuit 1. The control circuit 1 receives the first voltage control signal and continuously outputs the normal pulse signal, thereby forming a loop circuit.

The open protection circuit 6 acts as an open circuit when all the discharge lamps 4 are normally lit. The open protection circuit 6 instead produces a second voltage control signal and sends the second voltage control signal to the control circuit 1 when any of the discharge lamps 4 is not lit. Upon receiving the second voltage control signal, the control circuit 1 stops sending the normal pulse signal with a default duty cycle continuously. Thereupon the buck converter 2 stops outputting the higher DC voltage to the resonant converter 3, thereby preventing damage to the discharge lamps 4.

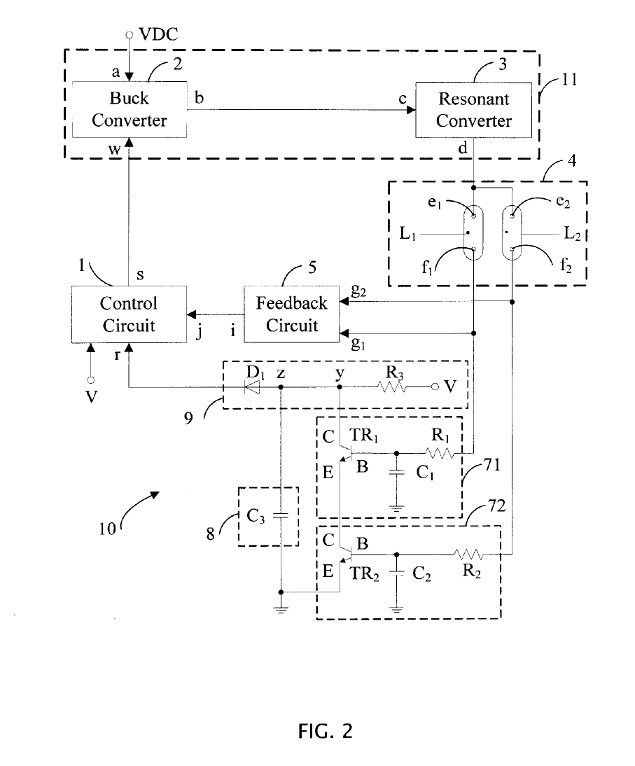

Referring also to FIG. 2, a discharge lamp lighting circuit 10 with an open protection circuit is detailed. The open protection unit 7 includes two open detecting circuits 71 and 72 corresponding to the arrangement of two discharge lamps 4. Each of the open detecting circuits 71 and 72 is used for detecting AC flowing through the corresponding discharge lamp 4. The open detecting circuit 71 includes a resistor R₁, a capacitor C₁, and a transistor TR₁. The open detecting circuit 72 includes a resistor R₂, a capacitor C₂, and a transistor TR₂. The delay circuit 8 includes a capacitor C₃. The open control circuit 9 includes a resistor R₃ and a diode D₁.

An end of the resistor R₁ is connected to the terminal ‘f₁’ of the discharge lamp L₁. An opposite end of the resistor R₁ is connected to a base terminal ‘B’ of the transistor TR₁ and an end of the capacitor C₁. An opposite end of the capacitor C₁ is grounded. A collector terminal ‘C’ of the transistor TR₁ is connected to a node ‘y’ between the resistor R₃ and the diode D₁.

An end of the resistor R₂ is connected to the terminal ‘f₂’ of the discharge lamp L₂. An opposite end of the resistor R₂ is connected to a base terminal ‘B’ of the transistor TR₂ and an opposite end of the capacitor C₂. A collector terminal C of the transistor TR₂ is connected to an emitter terminal ‘E’ of the transistor TR₁. An emitter terminal ‘E’ of the transistor TR₂ is connected to an end of the capacitor C₃ that is grounded. An opposite end of the capacitor C₃ is connected to a node ‘z’ between the resistor R₃ and the node ‘y’.

An anode of the diode D₁ is connected to an end of the resistor R₃, and a cathode of the diode D₁ is connected to the terminal ‘r’ of the control circuit 1. A reference voltage V is provided to an opposite end of the resistor R₃ from an AC power supply (not shown).

At the very start of supplying power to the discharge lamps L₁ and L₂, the discharge lamps L₁ and L₂ are not lit, and therefore the AC flow through the discharge lamps L₁ and L₂ is zero. Consequently, the transistors TR₁ and TR₂ do not conduct electricity through their corresponding collector terminal C and emitter terminal E, and the capacitor C₃ is charged by the AC power supply (not shown) of the reference voltage V until the charge is equal to the reference V after a predetermined period of time has elapsed. The predetermined period of time is dependant by a capacitance value of the capacitor C₃. Before the predetermined period of time has elapsed, the potential at the anode of the diode D₁ does not reach a first predetermined voltage that allows conductance. Furthermore, if both the discharge lamps L₁ and L₂ are lit, the discharge lamps L₁ and L₂ correspondingly output an AC.

The capacitors C₁ and C₂ integrate the corresponding AC from the discharge lamps L₁ and L₂ to generate a DC voltage, whereby the transistors TR₁ and TR₂ conduct itself. The capacitor C₃ then discharges to ground. As a result, the potential at the anode of the diode D₁ is reduced to zero, and therefore the diode D₁ does not conduct current.

After an initial ignition of the discharge lamps 4, the discharge lamps 4 are lit and enter a normal working state. During the normal working state, if one of the discharge lamps L₁ or L₂ is not lit, for example the discharge lamp L₁, then the terminal ‘f₁’ of the discharge lamp L₁ does not output AC to the transistor TR₁, and therefore the transistor TR₁ does not conduct current.

Consequently, the capacitor C₃ is charged by the AC power supply (not shown) of the reference voltage V until the charge is equal to the reference voltage V after a period of time has elapsed. Therefore the potential at the anode of the diode D₁ reaches the first predetermined voltage, and the diode D₁ conducts current and outputs the second voltage control signal to the control circuit 1. The control circuit 1 receives the second voltage control signal, and stops its operation. Thereupon the buck converter 2 stops outputting the higher DC voltage to the resonant converter 3, thereby prevents damage to the resonant converter 3 and the discharge lamps 4.

It should be emphasized that the above-described embodiments including preferred embodiments are merely possible examples of implementations, which are set forth for a clear understanding of the principles of the invention. Many variations and modifications may be made to the above-described embodiments. All such modifications and variations are intended to be included herein within the scope of this disclosure and the present invention, and protected by the following claims and their equivalents.

What is claimed is:

1. A discharge lamp lighting circuit comprising a plurality of discharge lamps, a driving circuit, a control circuit for controlling the driving circuit to power the discharge lamps, an open protection circuit, which are connected in series, wherein:
the open protection circuit comprises an open detecting unit, an open control circuit, and a delay circuit;
wherein the open detecting unit comprises a plurality of open detecting circuits connected in series, each open detecting circuit is connected to a corresponding one of the discharge lamps, a first predetermined one of the open detecting circuits is connected to the open control circuit, and a second predetermined one of the open detecting circuits is connected to one terminal of the delay circuit and ground;
one terminal of the open control circuit is connected to the control circuit, and the other terminal of the open control circuit is connected to the other terminal of the delay circuit and the second predetermined open detecting circuit; and
each of the open detecting circuits detects whether the corresponding discharge lamp is unlit; if the corresponding discharge lamp is not lit, the open control circuit sends a voltage control signal to the control circuit, which in turn ceases operating.

2. The discharge lamp lighting circuit according to claim 1, wherein the delay circuit comprises a capacitor, one end of the capacitor being connected to the second open detecting circuit and ground, the other end of the capacitor being connected to the open control circuit.

3. The discharge lamp lighting circuit according to claim 1, wherein each open detecting circuit further comprises a resistor, a capacitor, and a transistor.

4. The discharge lamp lighting circuit according to claim 3, wherein one end of the resistor is connected to a corresponding discharge lamp, and the other end of the resistor is connected to a base terminal of the transistor and one end of the capacitor, wherein the other end of the capacitor is grounded.

5. The discharge lamp lighting circuit according to claim 3, wherein a collector terminal of the transistor of one open detecting circuit is connected to the open control circuit or an emitter terminal of the transistor of another open detecting circuit, and an emitter terminal of the transistor of one open detecting circuit is connected to a collector of the transistor of another open detecting circuit or to the delay circuit and ground.

6. The discharge lamp lighting circuit according to claim 1, wherein the open control circuit further comprises a resistor and a diode, one end of the resistor being connected to a reference voltage, the other end of the resistor being connected to an anode of the diode, the delay circuit and the first predetermined one of the open detecting circuits, and a cathode of the diode being connected to the control circuit.

7. An open protection circuit, connected in series between a plurality of power consumers and a control circuit, the control circuit being configured for controlling a driving circuit to power the power consumers, the open protection circuit comprising:
an open detecting unit, an open control circuit and a delay circuit;
wherein the open detecting unit comprises a plurality of open detecting circuits connected in series, each open detecting circuit is connected to a corresponding one of the discharge lamps, a first predetermined one of the open detecting circuits is connected to the open control circuit, a second predetermined one of the open detecting circuits is connected to one terminal of the delay circuit and ground;
one terminal of the open control circuit is connected to the control circuit, and the other terminal of the open control circuit is connected to the other terminal of the delay circuit and the first predetermined one of the open detecting circuits; and
each of the open detecting circuits detects whether the corresponding discharge lamp is unlit; if the corresponding discharge lamp is not lit, the open control circuit sends a voltage control signal to the control circuit, which in turn ceases operating.

8. The discharge lamp lighting circuit according to claim 7, wherein the delay circuit comprises a capacitor, one end of the capacitor being connected to the second predetermined one of the open detecting circuits and ground, the other end of the capacitor being connected to the open control circuit.

9. The discharge lamp lighting circuit according to claim 7, wherein each open detecting circuit further comprises a resistor, a capacitor, and a transistor.

10. The discharge lamp lighting circuit according to claim 9, wherein one end of the resistor is connected to a discharge lamp, and the other end of the resistor is connected to a base terminal of the transistor and one end of the capacitor, wherein the other end of the capacitor is grounded.

11. The discharge lamp lighting circuit according to claim 9, wherein a collector terminal of the transistor of one open detecting circuit is connected to the open control circuit or an emitter terminal of the transistor of another open detecting circuit, and an emitter terminal of the transistor of one open detecting circuit is connected to a collector of the transistor of another open detecting circuit or to the delay circuit and ground.

12. The discharge lamp lighting circuit according to claim 7, wherein the open control circuit further comprises a resistor and a diode, one end of the resistor being connected to a reference voltage, the other end of the resistor being connected to an anode of the diode, the delay circuit and the first predetermined one of the open detecting circuits; a cathode of the diode being connected to the control circuit.
